(19) United States
(12) Patent Application Publication
(10) Pub. No.: US 2016/0052561 A1
(43) Pub. Date: Feb. 25, 2016

(54) VEHICLE BODY STRUCTURE

(71) Applicant: TOYOTA JIDOSHA KABUSHIKI KAISHA, Aichi (JP)

(72) Inventors: Hyuga ATSUMI, Toyota-shi (JP); Tetsuo NURUKI, Toyota-shi (JP); Sota SUGIMOTO, Toyota-shi (JP)

(73) Assignee: TOYOTA JIDOSHA KABUSHIKI KAISHA, Toyota-shi, Aichi (JP)

(21) Appl. No.: 14/781,393

(22) PCT Filed: Apr. 1, 2013
(86) PCT No.: PCT/JP13/60007

§ 371 Date: Sep. 30, 2015

(51) Int. Cl. B62D 25/20

(52) U.S. Cl. CPC B62D 25/2018

(57) ABSTRACT

A vehicle body structure is provided that is capable of increasing the degrees of freedom of applicable vehicle type, and that is capable of suppressing a cabin from deforming in a frontal collision by improving load transmission performance. A dash cross member is installed running along a vehicle width direction at a lower section of a dash panel. Rocker linking sections provided at both length direction end portions of the dash cross member are each joined to a rocker inner panel and a front pillar inner panel. A saddle shaped tunnel reinforcing section is formed at a length direction intermediate portion of the dash cross member, and is joined to a tunnel connection section of the dash panel.

### TECHNICAL FIELD

The present invention relates to a vehicle body structure.

### Background Art

Patent Document 1 describes a vehicle front section structure for suppressing a kick section of a front side member from deforming in a frontal collision. To explain briefly, a recessed portion recessed toward a vehicle cabin outer side is formed at a vehicle up-down direction intermediate portion of the kick section of the front side member, and a recessed portion that is superimposed on the above recessed portion is formed running along the vehicle width direction at a sloped wall portion formed to a vehicle up-down direction intermediate portion of a dash panel. The recessed portion of the dash panel is superimposed on the recessed portion of the kick section of the front side member, and a dash cross member formed with a hat shape cross-section profile is covered by, and linked together with, the recessed portion of the dash panel from the vehicle cabin inner side. The above background art is thereby capable of reinforcing the kick section of the front side member using the dash cross member, without reducing the space inner side the vehicle cabin.
Patent Document 1: Japanese Patent Application Laid-Open (JP-A) No. 2008-94134

### SUMMARY OF INVENTION

### Technical Problem

However, there is room for improvement of the background art, with respect to the points below.

In the background art, the recessed portion is formed to the kick section of the front side member and the recessed portion with the same cross-section profile is formed to a lower portion of the dash panel, these recessed portions are mutually superimposed and cover the dash cross member to form a closed cross-section structure, such that the vehicle body structure is complex, and applicable vehicle types are restricted.

Moreover, in general, a saddle shaped floor panel section that projects out toward the vehicle upper side and extends along the vehicle front-rear direction is installed at a vehicle width direction intermediate portion of a floor panel, and, accompanying this, a saddle shaped tunnel connection section for connecting to the floor panel section is formed at the lower portion of the dash panel. In the background art, a structure is formed in which the dash cross member is only joined to an apex wall portion of the tunnel connection section, such that collision load at a center portion side of the dash cross member is mainly transmitted to the apex wall portion side of the floor panel section. The rigidity provided to the floor tunnel section is thereby insufficiently utilized, and there is room for improvement of the background art regarding this point. In particular, there is demand in recent years to improve vehicle body structures with respect to a collision mode in which a large load is input, such as when the dash panel deforms in a direction tilting over from its base due to a brake booster pressing toward the vehicle rear side during a frontal collision, and there is also demand to resolve the above issue from this perspective.

In consideration of the above circumstances, an object of the present invention is to obtain a vehicle body structure capable of increasing the degrees of freedom of applicable vehicle type, and capable of suppressing a cabin from deforming in a frontal collision by improving load transmission performance.

### Solution to Problem

A vehicle body structure according to a first aspect includes: a floor panel that extends along a vehicle front-rear direction at a vehicle width direction intermediate portion and that is formed with a saddle shaped floor tunnel section bulging toward a vehicle upper side; a pair of left and right rockers that are disposed running along the vehicle front-rear direction at both vehicle width direction end portions of the floor panel; a pair of left and right front pillars that are provided extending toward the vehicle upper side from a front end portion of each rocker; a dash panel that is disposed between the pair of left and right front pillars, that partitions between a cabin and a vehicle body front chamber, that is joined to a front end portion of the floor panel, and that is formed with a tunnel connection section formed in a saddle shape at a lower portion of a vehicle width direction intermediate portion and joined to the floor tunnel section; and a dash cross member that is disposed at a vehicle cabin inner side of a lower section of the dash panel, that extends with a length direction thereof along the vehicle width direction, and that has length direction end portions joined to the rockers and a length direction intermediate portion formed in a saddle shape and joined to the tunnel connection section, thereby forming a vehicle body frame section with a closed cross-section structure that is contiguous along the vehicle width direction between the pair of left and right rockers and that is coupled together with the floor tunnel section through the tunnel connection section.

A vehicle body structure according to a second aspect is the first aspect, further including a front side member that includes a member main body section disposed running along the vehicle front-rear direction at the vehicle width direction outer side of the vehicle body front chamber, and a kick section extending out from a vehicle rear side end portion of the member main body section along a lower wall face of the dash panel toward a vehicle rear side and a vehicle lower side, wherein: the dash cross member includes an intermediate supporting section extending from a lower end of the length direction intermediate portion toward the vehicle width direction outer side; and the intermediate supporting section is disposed at a back face side of the kick section of the front side member, as viewed from a cabin side.

A vehicle body structure according to a third aspect is the second aspect, wherein the intermediate supporting section is disposed directly below an opening formed at to the dash panel and through which a portion of a steering shaft is inserted.

A vehicle body structure according to a fourth aspect is any one of the first aspect to the third aspect, wherein: a vertical cross-section profile of the rocker sectioned along the vehicle width direction and a vehicle up-down direction configures a rectangular shape; a vertical cross-section profile of the dash cross member sectioned along the vehicle front-rear direction and the vehicle up-down direction configures a hat shape open toward a dash panel side; and a dash cross member side fold portion positioned at a vehicle rear side and the vehicle upper side of the dash cross member, and a rocker side fold portion positioned at a vehicle width direction inner side and the vehicle upper side of the rocker, are connected together at a same height.

A vehicle body structure according to a fifth aspect is any one of the first aspect to the fourth aspect, further including: at an upper face side of the floor panel, a floor cross member that is provided at a vehicle rear side of the dash cross member and that, together with the floor panel, forms a vehicle body frame section with a closed cross-section structure running along the vehicle width direction, wherein a frame shaped frame section formed with a rectangular frame shape in plan view is formed by the floor tunnel section, the rocker, the dash cross member, and the floor cross member.

A vehicle body structure according to a sixth aspect is any one of the first aspect to the fifth aspect, further including: a tunnel reinforcement that is provided at an upper face side of the floor tunnel section and that, together with the floor tunnel section, forms a vehicle body frame section with a closed cross-section structure running along the vehicle front-rear direction, wherein a front end portion of the tunnel reinforcement is joined to the saddle shaped length direction intermediate portion of the dash cross member.

A vehicle body structure according to a seventh aspect is any one of the first aspect to the sixth aspect, further including: a floor reinforcement that is provided at an upper face side of the floor panel between the floor tunnel section and the rocker, and that, together with the floor panel, forms a vehicle body frame section with a closed cross-section structure running along the vehicle front-rear direction, wherein a front end portion of the floor reinforcement is joined to the dash cross member.

A vehicle body structure according to an eighth aspect is any one of the first aspect to the seventh aspect, wherein a vehicle width direction outer side end section of the dash cross member straddles, and is joined to, the rocker and the front pillar.

The first aspect enables the following operation. Namely, in the event of a large collision load during a frontal collision, the dash panel that partitions between the cabin and the vehicle body front chamber is sometimes pressed by a rigid body disposed in the vehicle body front chamber (such as a brake booster), and the dash panel attempts to deform by tilting over toward the cabin side from its base.

In the present aspect, the dash cross member having a length direction intermediate portion formed in a saddle shape is disposed with its length direction along the vehicle width direction at the vehicle cabin inner side of the lower section of the dash panel. Moreover, the length direction intermediate portion of the dash cross member is joined to the saddle shaped tunnel connection section formed to the lower section at the vehicle width direction intermediate portion of the dash panel. The length direction end portions of the dash cross member are joined to front end portions of the rockers. A vehicle body frame section with a closed cross-section structure is thereby formed that is contiguous along the vehicle width direction between the pair of left and right rockers, and that is also coupled to the floor tunnel section through the tunnel connection section. The base of the dash panel is reinforced as a result. In particular, the periphery of the tunnel connection section of the dash panel is effectively reinforced by a single frame that passes through not only an apex portion, but also includes both side portions. From out of collision load in a frontal collision, collision load that is transmitted to the length direction intermediate portion side of the dash cross member is thereby transmitted onward toward the vehicle rear side, including not only to the apex portion, but also to both the side portions of the floor tunnel section. Tilting deformation toward the cabin side about the base of the dash panel is thereby effectively suppressed or prevented.

Moreover, in the present aspect, a configuration that reinforces the periphery of the tunnel connection section of the dash panel is mainly devised by the shape of the dash cross member, such that the vehicle body structure at the periphery of the tunnel connection section of the dash panel is extremely simple.

In the second aspect, the member main body section of the front side member is disposed running along the vehicle front-rear direction at the vehicle width direction outer side of the vehicle body front chamber. Collision load in a frontal collision is thereby input to the member main body section of the front side member, and then transmitted to the lower section of the dash panel through the kick section.

In the present aspect, the dash cross member includes the intermediate supporting section extending from the lower end of the length direction intermediate portion toward the vehicle width direction outer side, and the intermediate supporting section is disposed at the back face side of the kick section of the front side member, as viewed from the cabin side. Collision load transmitted from the kick section of the front side member to the lower section of the dash panel is thereby supported by the intermediate supporting section of the dash cross member. Collision load is then distributed and transmitted from the intermediate supporting section of the dash cross member to the floor tunnel section and the rockers.

In the third aspect, the dash panel is formed with the opening through which a portion of the steering shaft is inserted, and the intermediate supporting section of the cross member is disposed directly below the opening. This enables a location with low rigidity to be effectively reinforced by the intermediate supporting section of the dash cross member.

In the fourth aspect, the dash cross member side fold portion positioned at the vehicle rear side and vehicle upper side of the dash cross member, and the rocker side fold portion positioned at the vehicle width direction inner side and vehicle upper side of the rocker are connected together at the same height, such that an effective load transmission location of the dash cross member and an effective load transmission location of the rocker are connected without interruption.

In the fifth aspect, the floor cross member is provided to the upper face side of the floor panel at the vehicle rear side of the dash cross member, and the frame shaped frame section with a rectangular frame shape in plan view is formed by the floor tunnel section, the rocker, the dash cross member, and the floor cross member. This enables the base of the dash panel to be supported by the frame shaped frame section with a strong frame assembly. As a result, the dash panel is effectively suppressed or prevented from tilting deformation toward the cabin side about its base.

In the sixth aspect, the tunnel reinforcement is provided at the upper face side of the floor tunnel section, and a vehicle body frame section with a closed cross-section structure running along the vehicle front-rear direction is formed by the tunnel reinforcement and the floor tunnel section. The front end portion of the tunnel reinforcement is joined to the saddle shaped length direction intermediate portion of the dash cross member, such that the dash cross member is supported from the vehicle rear side by the vehicle body frame section. The dash panel is accordingly even less liable to tilt over toward the cabin side.

In the seventh aspect, the floor reinforcement is provided between the floor tunnel section and the rocker at the upper face side of the floor panel, and a vehicle body frame section with a closed cross-section structure running along the vehicle front-rear direction is formed by the floor reinforcement and the floor tunnel. The front end portion of the floor reinforcement is joined to the dash cross member, such that the dash cross member is supported from the vehicle rear side by the vehicle body frame section. The dash panel is thereby even less likely to tilt over toward the cabin side.

In the eighth aspect, the vehicle width direction outer side end portion of the dash cross member straddles between, and is joined to, the rocker and the front pillar, such that part of the collision load transmitted to the dash cross member from the dash panel is transmitted to the front pillar. This thereby enables a larger collision load to be withstood than in cases in which the vehicle width direction outer side end portion of the dash cross member is only joined to the rocker.

### ADVANTAGEOUS EFFECTS OF INVENTION

As explained above, the vehicle body structure according to the first aspect includes excellent advantageous effects of enabling the degrees of freedom of applicable vehicle types to be increased, and enabling the cabin to be suppressed from deforming in a frontal collision, due to improved load transmission performance.

The vehicle body structure according to the second aspect includes an excellent advantageous effect of enabling the cabin to be effectively suppressed or prevented from deforming in a frontal collision.

The vehicle body structure according to the third aspect includes an excellent advantageous effect of enabling the cabin to be effectively suppressed or prevented from deforming in a frontal collision.

The vehicle body structure according to the fourth aspect includes an excellent advantageous effect of enabling loss to be reduced when transmitting load from the dash cross member to the rocker.

The vehicle body structure according to the fifth aspect includes an excellent advantageous effect of enabling the cabin to be extremely effectively suppressed or prevented from deforming in a frontal collision, due to the dash cross member being supported by the entire frame shaped frame section.

The vehicle body structure according to the sixth aspect includes an excellent advantageous effect of enabling the cabin to be extremely effectively suppressed or prevented from deforming in a frontal collision, due to adding a vehicle body frame member that supports the dash cross member.

The vehicle body structure according to the seventh aspect includes an excellent advantageous effect of enabling the cabin to be extremely effectively suppressed or prevented from deforming in a frontal collision, due to adding a vehicle body frame member that supports the dash cross member.

The vehicle body structure according to the eighth aspect includes an excellent advantageous effect of enabling the cabin to be extremely effectively suppressed or prevented from deforming in a frontal collision, due to collision load input to the dash cross member being transmitted not only to the rocker, but also to the front pillar.

### BRIEF DESCRIPTION OF DRAWINGS

FIG. 1 is a perspective view illustrating a vehicle body structure according to an exemplary embodiment, as viewed from a vehicle cabin inner side.

FIG. 2 is a perspective view illustrating a state in which a dash cross member has been removed from the vehicle body structure illustrated in FIG. 1.

FIG. 3 is an enlarged perspective view of relevant portions illustrating an enlargement of section of the vehicle body structure illustrated in FIG. 1.

FIG. 4 is a perspective view corresponding to FIG. 3, illustrating a state in which a front pillar inner panel is separated from the vehicle body structure illustrated in FIG. 3.

FIG. 5 is a vertical cross-section taken along line 5-5 in FIG. 1.

FIG. 6 is a vertical cross-section taken along line 6-6 in FIG. 1.

### DESCRIPTION OF EMBODIMENTS

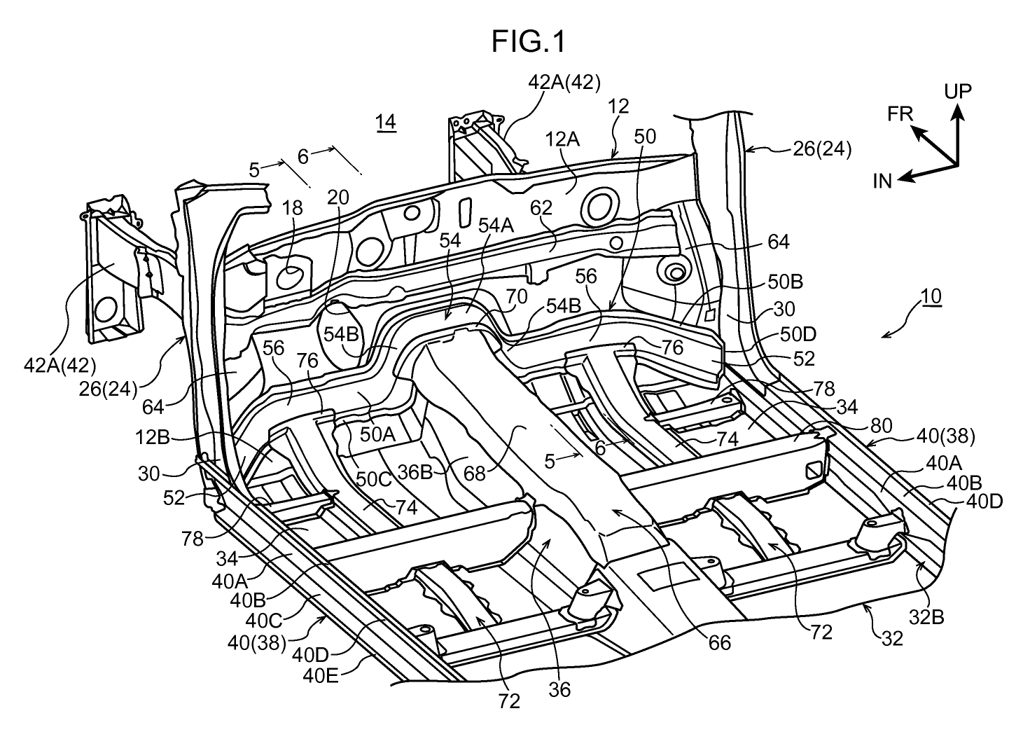

Explanation follows regarding an exemplary embodiment of a vehicle body structure according to the present invention, with reference to FIG. 1 to FIG. 6. Note that in the drawings, the arrow FR indicates the vehicle front side, the arrow UP indicates the vehicle upper side, and the arrow IN indicates the vehicle width direction inner side, as appropriate. A left-hand drive vehicle is illustrated in the drawings.

Dash Panel 12

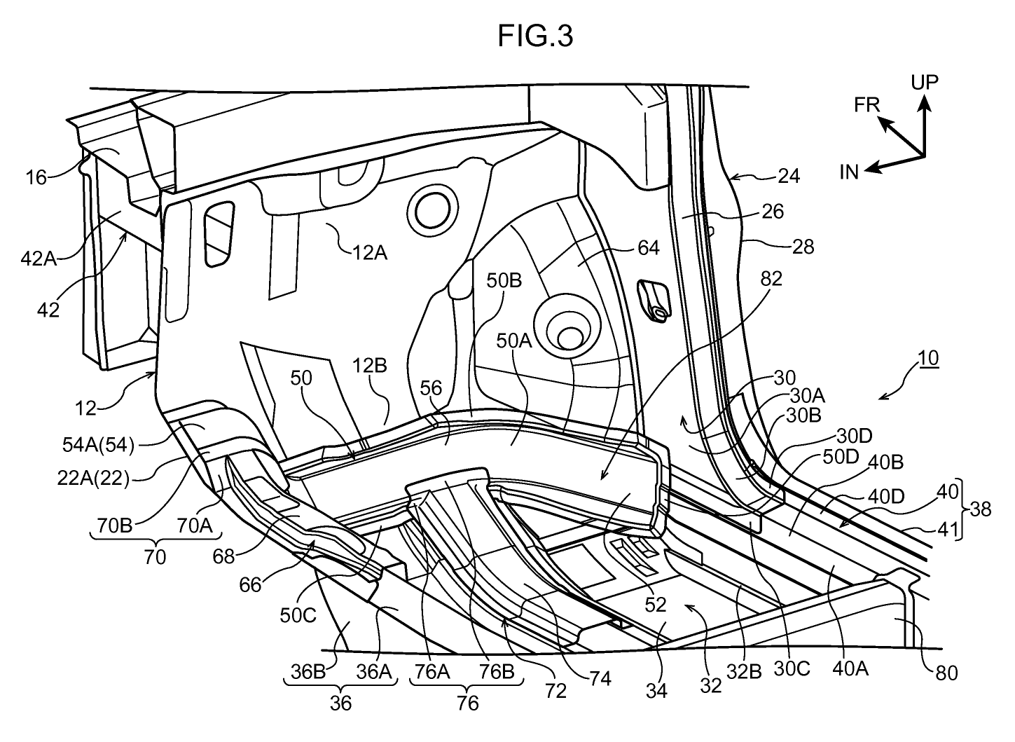

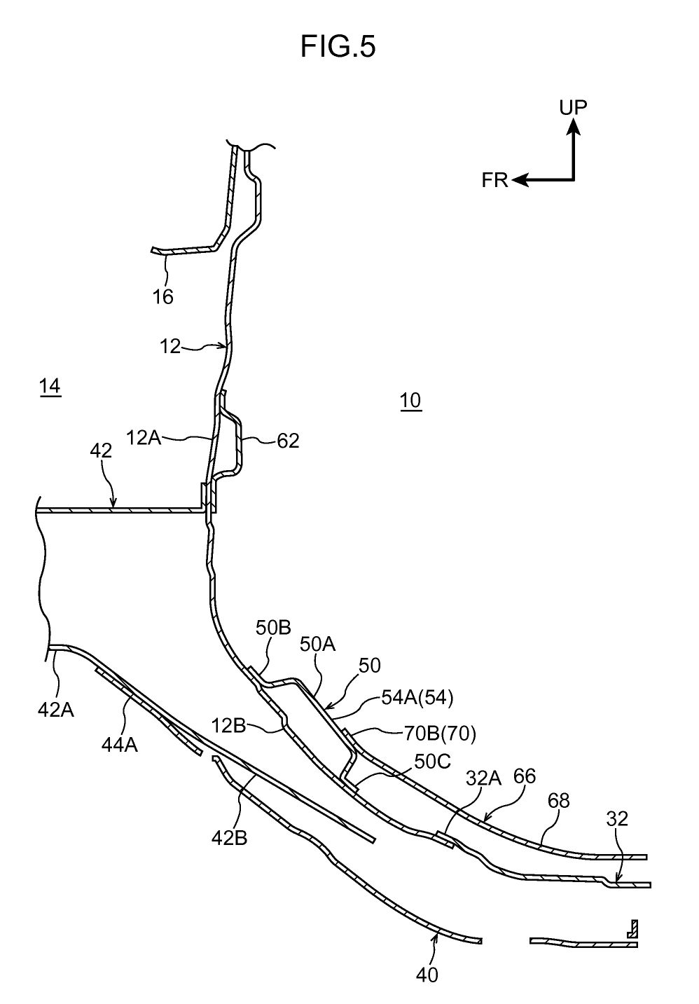

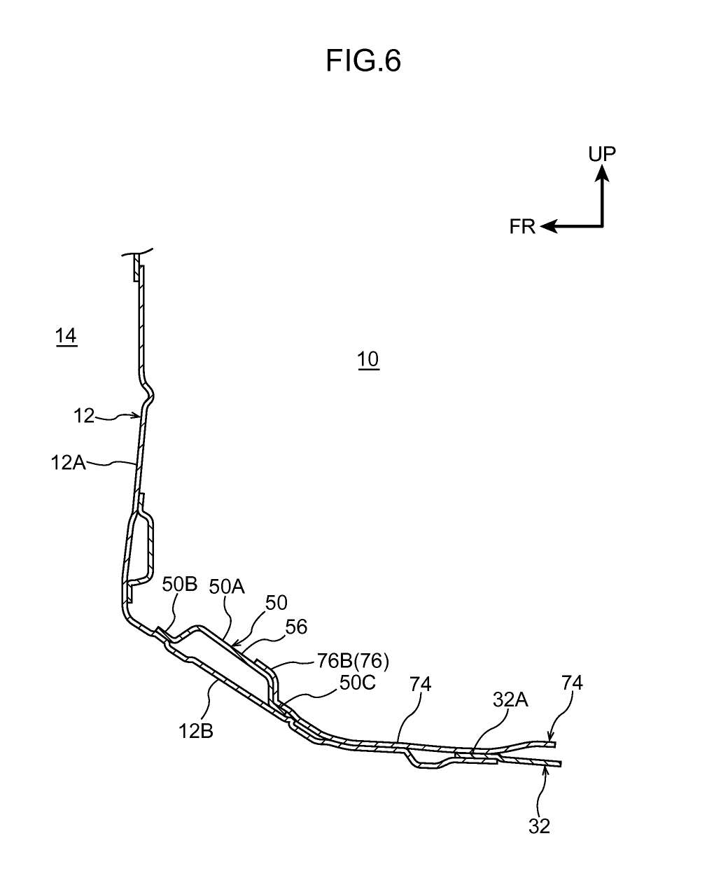

As illustrated in FIG. 1 to FIG. 4, a dash panel 12 extending along the vehicle width direction and the vehicle up-down direction stands upright at a front end section of a cabin 10. The cabin 10 is partitioned from a vehicle body front chamber 14 by the dash panel 12. The dash panel 12 is configured including an upper section 12A that is disposed vertically, and a lower section 12B that bends diagonally toward the vehicle lower rear side from a lower end of the upper section 12A. An upper end portion of the upper section 12A is joined by spot welding or the like to a U-shaped cowl 16 (see FIG. 3) that extends in the vehicle width direction along a lower end portion of a windshield, not illustrated in the drawings. A lower end portion of the lower section 12B is joined by spot welding or the like to a front end portion 32A of a floor panel 32 (see FIG. 5, FIG. 6), described later.

Two openings 18, 20, each with a different size, are formed at a driving seat side of the upper section 12A of the dash panel 12. The opening 18 formed at the upper side of the upper section 12A is formed in a substantially circular shape, and is an opening inserted with a push rod that couples together a brake booster and a brake pedal, not illustrated in the drawings, in the vehicle front-rear direction, and that transmits tread force imparted to a pedal pad of the brake pedal to the brake booster. The opening 20 formed at the lower side of the upper section 12A is formed in a substantially elliptical shape, and is an opening inserted with a steering shaft (intermediate shaft), not illustrated in the drawings. Note that the opening area of the opening 20 is set larger than the opening area of the opening 18.

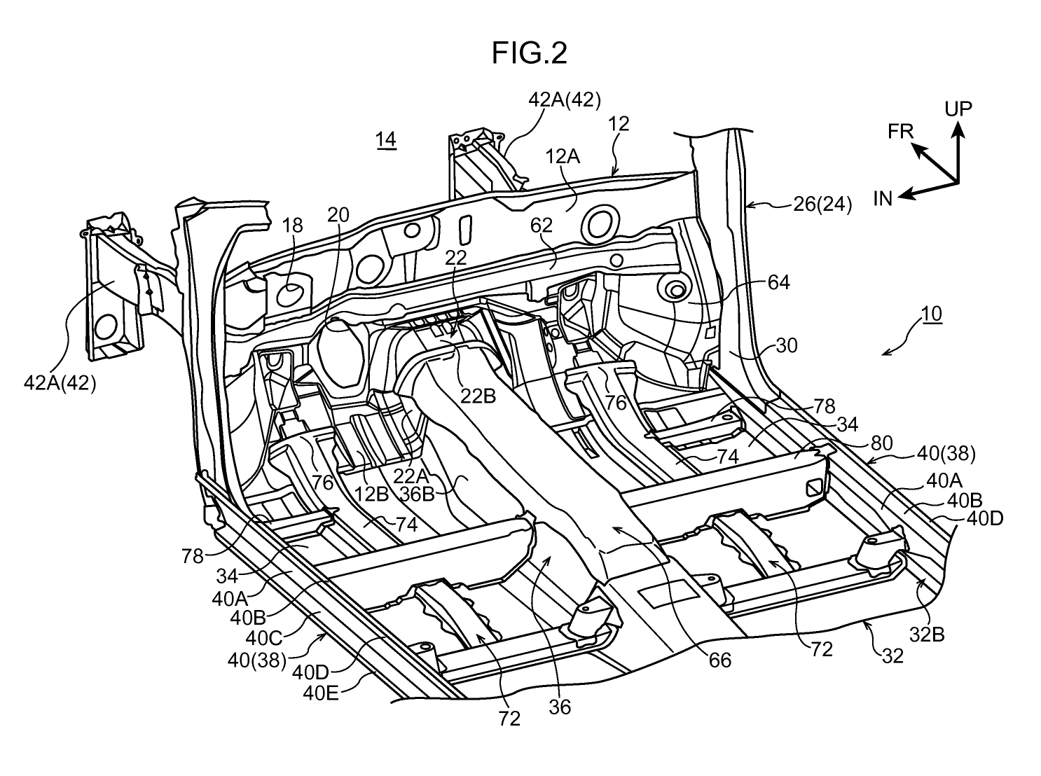

As illustrated in FIG. 2, a tunnel connection section 22 is integrally formed to the lower section 12B of the dash panel 12. The tunnel connection section 22 is formed at a vehicle width direction intermediate portion of the dash panel 12, and is formed in a saddle shape including an apex portion 22A and both side portions 22B that bend from both vehicle width direction end portions of the apex portion 22A toward the vehicle lower side.

Front Pillars 24

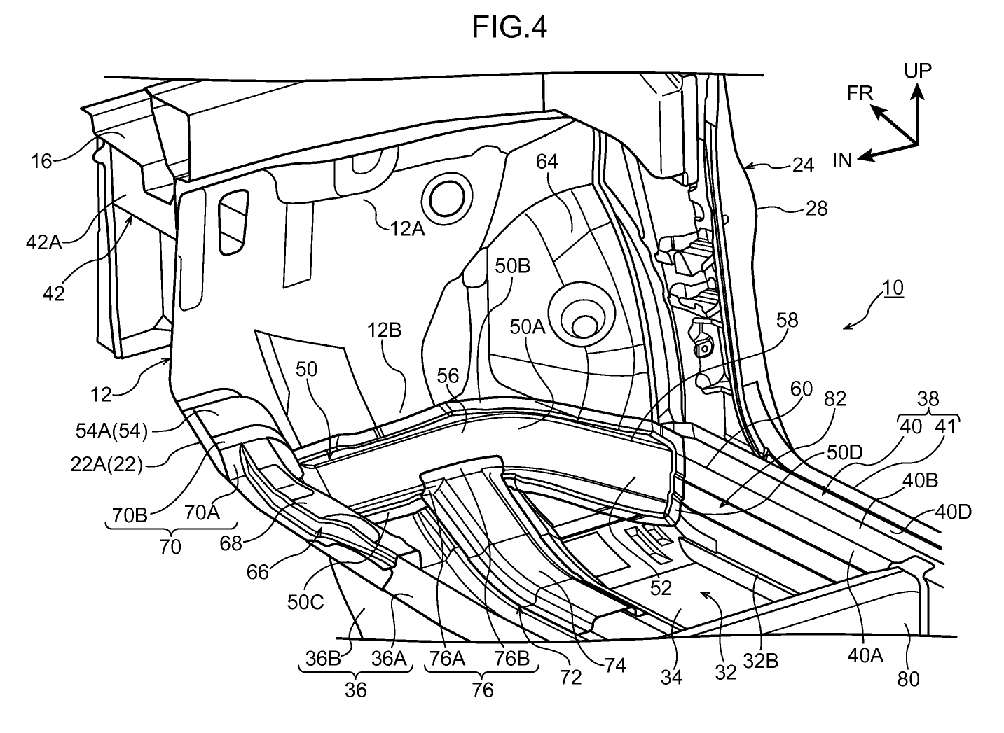

As illustrated in FIG. 1 to FIG. 4, a pair of left and right front pillars 24, each configured as a column shaped frame member, stand upright at both vehicle width direction end portions of the above-described dash panel 12. Each front pillar 24 is configured as a closed cross-section structure by a front pillar inner panel 26, formed with a hat shaped plan cross-section profile and disposed at the vehicle width direction inner side with the open side toward the vehicle cabin outer side, and a front pillar outer panel 28, formed with a hat shaped plan cross-section profile and disposed at the vehicle width direction outer side of the front pillar inner panel 26 with the open side toward the vehicle cabin inner side (see FIG. 3, FIG. 4).

To elaborate regarding the detailed structure of the front pillar inner panel 26, as illustrated in FIG. 3 and FIG. 4, a lower section 30 of the front pillar inner panel 26 includes a bottom wall portion 30A with a splayed shape (skirt shape) profile in vehicle side view, a rear wall portion 30B bending from a rear end portion of the bottom wall portion 30A toward the vehicle width direction outer side, a lower flange portion 30C extending out from a lower end portion of the bottom wall portion 30A toward the vehicle lower side, and a rear flange portion 30D bending from a vehicle width direction outer side end portion of the rear wall portion 30B toward a door opening side. Although not illustrated in FIG. 3 or FIG. 4, a front end portion side of the bottom wall portion 30A is configured similarly to the rear end portion side of the bottom wall portion 30A. The lower section 30 of the front pillar inner panel 26 with the above configuration is mounted onto a front end portion of an upper wall portion 40B of a rocker inner panel 40 (a front end portion of a rocker 38), described later, and is joined by spot welding or the like to an upright wall portion 40A, the upper wall portion 40B, and an upper flange portion 40D of the rocker inner panel 40.

Floor Panel 32

As illustrated in FIG. 1 to FIG. 4, the floor panel 32 formed in a substantially rectangular shape in plan view is installed at a bottom section of the cabin 10. As described above, the front end portion 32A of the floor panel 32 (see FIG. 5, FIG. 6) is joined by spot welding or the like to an end portion of the lower section 12B of the dash panel 12. The floor panel 32 includes flat plate shaped general floor sections 34 installed with front seats and rear seats, not illustrated in the drawings, and a floor tunnel section 36 installed with its length direction along the vehicle front-rear direction between the driving seat and a front passenger seat. The floor tunnel section 36 is formed in a saddle shape bulging toward the vehicle upper side with respect to the general floor sections 34, and includes an apex portion 36A (see FIG. 3, FIG. 4), and a pair of left and right both side portions 36B bending from both vehicle width direction end portions of the apex portion 36A toward the vehicle lower side. A front end portion of the floor tunnel section 36 is joined by spot welding or the like to the tunnel connection section 22 of the dash panel 12, described above. The floor tunnel section 36 is thereby formed with an open cross-section profile open toward the vehicle lower side. In the present embodiment, the floor tunnel section 36 is integrally formed to the general floor sections 34; however, configuration is not limited thereto. The floor tunnel section 36 and the general floor sections 34 may be formed separately, and both members integrated by being joined together by spot welding or the like to configure a floor panel.

Rockers 38

The rockers 38 are installed extending along the vehicle front-rear direction at both vehicle width direction end portions of the above-described floor panel 32. Each rocker 38 is configured with a rectangular shaped closed cross-section structure by the rocker inner panel 40, formed with a hat shaped vertical cross-section profile and disposed at the vehicle width direction inner side with the open side toward the vehicle cabin outer side, and a rocker outer panel 41, formed with a hat shaped vertical cross-section profile and disposed at the vehicle width direction outer side of the rocker inner panel 40 with the open side toward the vehicle cabin inner side (see FIG. 3, FIG. 4).

To elaborate regarding the detailed structure of the rocker inner panel 40, as illustrated in FIG. 3 and FIG. 4, the rocker inner panel 40 is configured by the upright wall portion 40A extending along the vehicle up-down direction and the vehicle front-rear direction and disposed perpendicularly to the floor panel 32, the upper wall portion 40B bending from an upper end portion of the upright wall portion 40A toward the vehicle width direction outer side, a lower wall portion 40C bending from a lower end portion of the upright wall portion 40A toward the vehicle width direction outer side, the upper flange portion 40D bending at a right angle from a vehicle width direction outer side end portion of the upper wall portion 40B, and a lower flange portion 40E bending at a right angle from a vehicle width direction outer side end portion of the lower wall portion 40C. A floor terminal portion 32B, formed at the vehicle width direction outer side of each general floor section 34 described above, is joined by spot welding or the like to the upright wall portion 40A. As described above, a front end portion of the rocker inner panel 40 is mounted with the lower section 30 of the front pillar inner panel 26, and the bottom wall portion 30A, the lower flange portion 30C, and the rear flange portion 30D of the lower section 30 are joined by spot welding or the like to the upper wall portion 40B, the upright wall portion 40A, and the upper flange portion 40D of the rocker inner panel 40 in this state.

Front Side Members 42

A pair of left and right front side members 42 are installed at the vehicle width direction outer sides of the vehicle body front chamber 14. Structurally, each front side member 42 includes a member main body section 42A disposed along the vehicle front-rear direction at the vehicle width direction outer side of the vehicle body front chamber 14, and a kick section 42B extending diagonally toward the vehicle rear and vehicle lower side from a rear end portion of the member main body portion 42A along a curved face of the lower section 12B of the dash panel 12. Note that a front end portion 44A of a floor side member 44 that is disposed at a lower face side of the floor panel 32 and extends along the vehicle front-rear direction is joined by spot welding or the like to the kick section 42B of the front side member 42.

Dash Cross Member 50

As illustrated in FIG. 1 to FIG. 4, a dash cross member 50 is installed at the vehicle cabin inner side of the lower section 12B of the dash panel 12, described above. Detailed explanation follows regarding configuration of the dash cross member 50.

The dash cross member 50 extends with its length direction along the vehicle width direction, and is installed spanning between the left and right front pillars 24. In terms of elements, the dash cross member 50 is configured by rocker linking sections 52 disposed at both length direction end portions, a tunnel reinforcing section 54 disposed at a length direction intermediate portion, and a pair of left and right intermediate supporting sections 56 disposed between the respective rocker linking sections 52 and the tunnel reinforcing section 54.

The dash cross member 50 is configured with a hat shaped vertical cross-section profile. The dash cross member 50 accordingly includes a substantially U-shaped main body portion 50A disposed such that the open side faces the lower section 12B of the dash panel 12, an upper flange portion 50B bending toward the vehicle upper side from a front end of an upper wall of the main body portion 50A, a lower flange portion 50C bending toward the vehicle lower side from a front end of a lower wall of the main body portion 50A, and lateral flange portions 50D bending toward the vehicle width direction outer sides from both length direction ends of the main body portion 50A.

As illustrated in FIG. 3 and FIG. 4, the upper flange portion 50B and the lower flange portion 50C provided at the tunnel reinforcing section 54 and the intermediate supporting sections 56 of the dash cross member 50 are joined by spot welding or the like to the lower section 12B of the dash panel 12. The upper flange portion 50B provided at each rocker linking section 52 of the dash cross member 50 is joined by spot welding or the like to the bottom wall portion 30A of the front pillar outer panel 28, described above. The lower flange portion 50C at each rocker linking section 52 is joined by spot welding or the like to the lower section 12B of the dash panel 12. The lateral flange portion 50D provided at each rocker linking section 52 straddles across the bottom wall portion 30A of the front pillar outer panel 28 and the upright wall portion 40A of the rocker inner panel 40, and is joined thereto by spot welding or the like. The rocker linking section 52 is thereby joined to three members, these being the front pillar 24, the rocker 38, and the floor panel 32.

To elaborate, as illustrated in FIG. 4, a first ridgeline portion 58, serving as a dash cross member side fold portion formed by an upper wall and an upright wall of the rocker linking section 52 of the dash cross member 50, is connected to a second ridgeline portion 60, serving as a rocker side fold portion formed by an upper wall and an upright wall of the rocker inner panel 40, such that the respective heights are aligned. The first ridgeline portion 58 is positioned at the vehicle rear side and vehicle upper side of the dash cross member 50, and the second ridgeline portion 60 is positioned at the vehicle width direction inner side and vehicle upper side of the rocker 38.

As illustrated in FIG. 1 and FIG. 2, the intermediate supporting section 56 of the dash cross member 50 is disposed directly below the above-described opening 20 formed in the dash panel 12. Each intermediate supporting section 56 of the dash cross member 50 is disposed at a back face side of the kick section 42B of the front side member 42, as viewed from the cabin 10 side (see FIG. 5).

The tunnel reinforcing section 54 of the dash cross member 50 is formed in a saddle shape so as to follow the shape of the tunnel connection section 22 of the dash panel 12, and is configured by an apex reinforcing portion 54A, and a pair of left and right side portion reinforcing portions 54B that bend diagonally toward the vehicle lower outer side from both vehicle width direction ends of the apex reinforcing portion 54A. Note that “saddle shape” refers to the tunnel reinforcing section 54 having a shape formed in a “vertically inverted, substantially U-shape” as viewed from the vehicle rear side. The tunnel reinforcing section 54 with the above configuration is joined to the tunnel connection section 22 from the vehicle cabin inner side, such that a vehicle body frame section with a closed cross-section structure is formed around (across the entire periphery of) the tunnel connection section 22. The front end portion of the floor tunnel section 36 is joined by spot welding or the like to the tunnel connection section 22. The tunnel reinforcing section 54 is thereby also coupled to the floor tunnel section 36 of the floor panel 32 through the tunnel connection section 22 of the dash panel 12.

Due to the above configuration centered on the dash cross member 50, the dash cross member 50 configures a vehicle body frame section that couples together the front end portions of the left and right rockers 38, and is installed along the vehicle width direction at the lower section 12B of the dash panel 12, namely, at the base of the dash panel 12. In particular, a vehicle body frame section with a closed cross-section structure, formed by the dash cross member 50 and the dash panel 12 across the entire periphery of the tunnel connection section 22 of the dash panel 12 connected to the floor tunnel section 36 that bulges out toward the vehicle upper side at a higher position than the height of the rockers 38, forms a structure serving as a single frame that is installed contiguously without interruption.

Peripheral Structure of Dash Cross Member 50

Dash reinforcement 62 is installed along the vehicle width direction at the upper section 12A of the dash panel 12. The dash reinforcement 62 is formed with a hat shaped vertical cross-section profile, and is installed spanning between bulge portions 64 at both left and right sides of the dash panel 12. The dash cross member 50 is installed so as to pass between the upper and lower openings 18, 20 at the driving seat side, and is installed such that the lower side opening 20 is vertically sandwiched between the dash reinforcement 62 and the intermediate supporting section 56 of the dash cross member 50.

Tunnel reinforcement 66 with a hat shaped vertical cross-section profile is installed at the apex portion 36A of the floor tunnel section 36, described above. The tunnel reinforcement 66 is configured by a hat shaped main body section 68 open toward the vehicle lower side, and a leading end supporting section 70 that bends in a fan shape from a front end portion of the main body section 68. The main body section 68 is fitted into the floor tunnel section 36 and joined thereto by spot welding or the like. The leading end supporting section 70 bends in an L-shape, and is configured by rear supporting portion 70A that supports a rear wall of the tunnel reinforcing section 54 of the dash cross member 50 from the vehicle rear side, and an upper-side supporting portion 70B that presses into an upper wall of the tunnel reinforcing section 54 from the vehicle upper side, and presses into both side walls of the tunnel reinforcing section 54 from the vehicle width direction outer sides.

Floor reinforcement 72 is installed running along the vehicle front-rear direction between the rocker 38 and the floor tunnel section 36 at each general floor section 34 of the floor panel 32, described above. The floor reinforcement 72 is configured by a hat shaped main body section 74 open toward the vehicle lower side, and a leading end supporting section 76 bending in an L-shape from a front end portion of the main body section 74. The main body section 74 is joined by spot welding or the like to an upper face of the general floor section 34. The leading end supporting section 76 is configured by a rear supporting portion 76A that supports a rear wall of the intermediate supporting section 56 of the dash cross member 50 from the vehicle rear side, and an upper supporting portion 76B that presses into an upper wall of the intermediate supporting section 56 from the vehicle upper side. A small cross member 78, formed with a hat shape open toward the vehicle lower side, is installed between a front portion of the floor reinforcement 72 and the rocker 38. The floor reinforcement 72 and the rocker 38 are thereby coupled together along the vehicle width direction.

A floor cross member 80, running parallel to the dash cross member 50 at the vehicle rear side thereof, is installed to the general floor sections 34 of the floor panel 32. The floor cross member 80 is formed in a hat shape open toward the vehicle lower side, and is joined by spot welding or the like to the general floor sections 34. A vehicle width direction inner side end portion of the floor cross member 80 is joined by spot welding or the like to the side portions 36B of the floor tunnel section 36, and the vehicle width direction outer side end portions of the floor cross member 80 are joined by spot welding or the like to the upright wall portions 40A of the rocker inner panels 40. A vehicle body frame section with a closed cross-section structure running along the vehicle width direction is thereby formed by the floor cross member 80 and the floor panel 32. In other words, a frame shaped frame section 82 with a rectangular frame shape in plan view is formed by the floor tunnel section 36, the rockers 38, the dash cross member 50, and the floor cross member 80.

Operation and Advantageous Effects

Explanation follows regarding operation and advantageous effects of the present exemplary embodiment.

In the event of a large collision load in a frontal collision, the dash panel 12 that partitions between the cabin 10 and the vehicle body front chamber 14 is sometimes pressed by a rigid body disposed in the vehicle body front chamber 14 (such as the brake booster), and the dash panel 12 attempts to deform by tilting over toward the cabin 10 side from its base. Such collisions include, for example, small overlap collisions involving a collision with a barrier at the vehicle width direction outer side of the front side member 42, offset collisions in which an overlap amount with a barrier is greater than in a small overlap collision, and oblique collisions involving a collision with a barrier obliquely from the front of the vehicle body front section. In such collisions, cases in which the collision speed is relatively fast, and cases in which the weight of the barrier is relatively heavy, are liable to occur.

In the present exemplary embodiment, the dash cross member 50, with its length direction intermediate portion formed in a saddle shape, is disposed with its length direction along the vehicle width direction at the vehicle cabin inner side of the lower section 12B of the dash panel 12. Moreover, the tunnel reinforcing section 54 disposed at the length direction intermediate portion of the dash cross member 50 is joined to the saddle shaped tunnel connection section 22 formed to the lower section 12B at the vehicle width direction intermediate portion of the dash panel 12. The rocker linking sections 52 at the length direction end portions of the dash cross member 50 are joined to the front end portions of the rockers 38. A vehicle body frame section with a closed cross-section structure is thereby formed that is contiguous along the vehicle width direction between the front end portions of the pair of left and right rockers 38, and that is also coupled to the floor tunnel section 36 through the tunnel connection section 22. The base of the dash panel 12 is reinforced as a result. In particular, the periphery of the tunnel connection section 22 is effectively reinforced by a single frame that passes through not only the apex portion 22A, but also includes both the side portions 22B. Of collision load in a frontal collision, collision load that is transmitted to the tunnel reinforcing section 54 side of the dash cross member 50 is thereby transmitted toward the vehicle rear side, not only through the apex portion 36A, but also through both the side portions 36B of the floor tunnel section 36. The dash panel 12 is thereby effectively suppressed or prevented from tilting deformation toward the cabin 10 side about its base.

In the present exemplary embodiment, a configuration that reinforces the periphery of the tunnel connection section 22 of the dash panel 12 is mainly devised by the shape of the dash cross member 50, such that the vehicle body structure at the periphery of the tunnel connection section 22 of the dash panel 12 is extremely simple.

Thus the present exemplary embodiment enables the degrees of freedom of applicable vehicle types to be increased, and enables the cabin 10 to be suppressed from deforming in a frontal collision by improved load transmission performance.

In the present exemplary embodiment, the pair of left and right front side members 42 are disposed running along the vehicle front-rear direction at the vehicle width direction outer sides of the vehicle body front chamber 14. Collision load in a frontal collision is thereby input to the member main body sections 42A of the front side members 42, and then transmitted to the lower section 12B of the dash panel 12 through the kick sections 42B.

In the present exemplary embodiment, the dash cross member 50 is provided with the intermediate supporting sections 56, and the intermediate supporting sections 56 are disposed at the back face sides of the kick sections 42B of the front side members 42, as viewed from the cabin 10 side. Collision load transmitted from the kick sections 42B of the front side members 42 to the lower section 12B of the dash panel 12 is thereby supported by the intermediate supporting sections 56 of the dash cross member 50. Collision load is then distributed and transmitted from the intermediate supporting sections 56 of the dash cross member 50 to the floor tunnel section 36 and the rockers 38. The present exemplary embodiment thereby enables the cabin to be effectively suppressed or prevented from deforming in a frontal collision.

In the present exemplary embodiment, the dash panel 12 is formed with the opening 20 inserted with the intermediate shaft, this being a portion of the steering shaft, and the intermediate supporting section 56 of the dash cross member 50 is disposed directly below the opening 20. This enables a location of the dash panel 12 that has low rigidity to be effectively reinforced by the intermediate supporting section 56 of the dash cross member 50. The present exemplary embodiment thereby enables the cabin 10 to be even more effectively suppressed or prevented from deforming in a frontal collision.

In the present exemplary embodiment, the first ridgeline portion 58 positioned at the vehicle rear side and vehicle upper side of the dash cross member 50, and the second ridgeline portions 60 positioned at the vehicle width direction inner side and vehicle upper side of the rockers 38 are connected together at the same height, such that an effective load transmission location of the dash cross member 50 and an effective load transmission location of the rockers 38 are connected without interruption. The present exemplary embodiment thereby enables loss when transmitting load from the dash cross member 50 to the rockers 38 to be reduced.

In the present exemplary embodiment, the floor cross member 80 is provided to the upper face side of the floor panel 32 at the vehicle rear side of the dash cross member 50, and the frame shaped frame section 82 with a rectangular frame shape in plan view is formed by the floor tunnel section 36, the rockers 38, the dash cross member 50, and the floor cross member 80. This enables the base of the dash panel 12 to be supported by the frame shaped frame section 82 with a strong frame assembly. The dash panel 12 is thereby effectively suppressed or prevented from tilting deformation toward the cabin 10 side about its base. Thus in the present exemplary embodiment, since the dash cross member 50 is supported by the entire frame shaped frame section 82, the cabin 10 can be extremely effectively suppressed or prevented from deforming in a frontal collision.

In the present exemplary embodiment, the tunnel reinforcement 66 is provided at an upper face side of the floor tunnel section 36, and a vehicle body frame section with a closed cross-section structure running along the vehicle front-rear direction is formed by the tunnel reinforcement 66 and the floor tunnel section 36. The leading end supporting section 70 at the front end portion of the tunnel reinforcement 66 is joined to the saddle shaped tunnel reinforcing section 54 of the dash cross member 50, such that the dash cross member 50 is supported from the vehicle rear side by the vehicle body frame section. The dash panel 12 is accordingly even less liable to tilt over toward the cabin 10 side. Thus in the present exemplary embodiment, adding a vehicle body frame member that supports the dash cross member 50 enables the cabin 10 to be extremely effectively suppressed or prevented from deforming in a frontal collision.

In the present exemplary embodiment, the floor reinforcements 72 are provided between the floor tunnel section 36 and the rockers 38 at an upper face side of the floor panel 32, and a vehicle body frame section with a closed cross-section structure running along the vehicle front-rear direction is formed by the floor reinforcements 72 and the floor tunnel section 36. The leading end supporting sections 76 at the front end portions of the floor reinforcements 72 are joined to the dash cross member 50, such that the dash cross member 50 is supported from the vehicle rear side by the vehicle body frame section. The dash panel 12 is thereby even less likely to tilt over toward the cabin 10 side. Thus in the present exemplary embodiment, adding a vehicle body frame member that supports the dash cross member 50 enables the cabin 10 to be extremely effectively suppressed or prevented from deforming in a frontal collision.

In the present exemplary embodiment, the rocker linking sections 52 at both length direction end portions of the dash cross member 50 each straddle between, and are joined to, the rocker 38 and the front pillar 24, such that part of the collision load transmitted to the dash cross member 50 from the dash panel 12 is transmitted to the front pillars 24. This enables a larger collision load to be withstood than in cases in which vehicle width direction outer side end portions of the dash cross member 50 are only joined to the rockers 38. Thus in the present exemplary embodiment, collision load input to the dash cross member 50 is transmitted not only to the rockers 38, but also to the front pillars 24, thereby enabling the cabin 10 to be extremely effectively suppressed or prevented from deforming in a frontal collision.

Supplementary Explanation of Exemplary Embodiment

(1) In the above-described exemplary embodiment, a configuration has been adopted in which the tunnel reinforcement 66 and the floor reinforcements 72 support the dash cross member 50 from the vehicle rear side; however configuration is not limited thereto, and a vehicle body structure may be applied in which only one of these members is provided, or a vehicle body structure may be applied in which neither of these members are provided.

(2) In the above-described exemplary embodiment, the rocker linking sections 52 disposed at both length direction end portions of the dash cross member 50 each straddle between, and are joined to, the front pillar inner panel 26 and the rocker inner panel 40; however configuration is not limited thereto, and a configuration may be applied in which both length direction end portions of a dash cross member are only joined to a rocker inner panel.

1. A vehicle body structure comprising:
a floor panel that extends along a vehicle front-rear direction at a vehicle width direction intermediate portion and that is formed with a saddle shaped floor tunnel section bulging toward a vehicle upper side;
a pair of left and right rockers that are disposed running along the vehicle front-rear direction at both vehicle width direction end portions of the floor panel;
a pair of left and right front pillars that are provided extending toward the vehicle upper side from a front end portion of each rocker;
a dash panel that is disposed between the pair of left and right front pillars, that partitions between a cabin and a vehicle body front chamber, that is joined to a front end portion of the floor panel, and that is formed with a tunnel connection section formed in a saddle shape at a lower portion of a vehicle width direction intermediate portion and joined to the floor tunnel section; and
a dash cross member that is disposed at a vehicle cabin inner side of a lower section of the dash panel, that extends with a length direction thereof along the vehicle width direction, and that has length direction end portions joined to the rockers and a length direction intermediate portion formed in a saddle shape and joined to the tunnel connection section, thereby forming a vehicle body frame section with a closed cross-section structure that is contiguous along the vehicle width direction between the pair of left and right rockers and that is coupled together with the floor tunnel section through the tunnel connection section.

2. The vehicle body structure of claim 1, further comprising
a front side member that includes a member main body section disposed running along the vehicle front-rear direction at the vehicle width direction outer side of the vehicle body front chamber, and a kick section extending out from a vehicle rear side end portion of the member main body section along a lower wall face of the dash panel toward a vehicle rear side and a vehicle lower side, wherein:
the dash cross member includes an intermediate supporting section extending from a lower end of the length direction intermediate portion toward the vehicle width direction outer side; and
the intermediate supporting section is disposed at a back face side of the kick section of the front side member, as viewed from a cabin side.

3. The vehicle body structure of claim 2, wherein
the intermediate supporting section is disposed directly below an opening formed at the dash panel and through which a portion of a steering shaft is inserted.

4. The vehicle body structure of claim 1, wherein:
a vertical cross-section profile of the rocker sectioned along the vehicle width direction and a vehicle up-down direction configures a rectangular shape;
a vertical cross-section profile of the dash cross member sectioned along the vehicle front-rear direction and the vehicle up-down direction configures a hat shape open toward a dash panel side; and
a dash cross member side fold portion positioned at a vehicle rear side and the vehicle upper side of the dash cross member, and a rocker side fold portion positioned at a vehicle width direction inner side and the vehicle upper side of the rocker, are connected together at a same height.

5. The vehicle body structure of claim 1, further comprising:
at an upper face side of the floor panel, a floor cross member that is provided at a vehicle rear side of the dash cross member and that, together with the floor panel, forms a vehicle body frame section with a closed cross-section structure running along the vehicle width direction, wherein
a frame shaped frame section formed with a rectangular frame shape in plan view is formed by the floor tunnel section, the rocker, the dash cross member, and the floor cross member.

6. The vehicle body structure of claim 1, further comprising:
a tunnel reinforcement that is provided at an upper face side of the floor tunnel section and that, together with the floor tunnel section, forms a vehicle body frame section with a closed cross-section structure running along the vehicle front-rear direction, wherein
a front end portion of the tunnel reinforcement is joined to the saddle shaped length direction intermediate portion of the dash cross member.

7. The vehicle body structure of claim 1, further comprising:
a floor reinforcement that is provided at an upper face side of the floor panel between the floor tunnel section and the rocker, and that, together with the floor panel, forms a vehicle body frame section with a closed cross-section structure running along the vehicle front-rear direction, wherein
a front end portion of the floor reinforcement is joined to the dash cross member.

8. The vehicle body structure of claim 1, wherein
a vehicle width direction outer side end section of the dash cross member straddles, and is joined to, the rocker and the front pillar.
